(19) United States
(12) Patent Application Publication
(10) Pub. No.: US 2018/0332819 A1
(43) Pub. Date: Nov. 22, 2018

(54) ANIMAL FEEDER

(71) Applicant: John Michalec, Boerne, TX (US)

(72) Inventor: John Michalec, Boerne, TX (US)

(21) Appl. No.: 15/597,482

(22) Filed: May 17, 2017

(51) Int. Cl. A01K 5/02; F21S 9/03; F21V 23/00

(52) U.S. Cl. CPC A01K 5/0291; F21Y 2103/10; F21V 23/002; F21S 9/037

(57) ABSTRACT

An animal feeder comprises an animal feeder, recessed lighting strips, a recessed solar panel, and a control unit. The animal feeder comprises a lid, a cage member, and four legs. The lid seals the animal feeder and the cage member is positioned below the animal feeder. The four legs support the animal feeder. The recessed lighting strips are detachably attached to predetermined sections of the animal feeder. The recessed solar panel is mounted within a sidewall of the animal feeder. The recessed solar panel is positioned at an inclination for receiving sunlight. The sidewall is further configured to prevent exposure of the solar panel to free falling objects. The recessed solar panel powers a rechargeable battery in the control unit, which is positioned on an inner surface of the animal feeder for powering the recessed lighting strips and actuates a supply port for dispensing feed at the predefined intervals. All wiring connections are unexposed to prevent damage.

### TECHNICAL FIELD OF THE INVENTION

The invention disclosed herein generally relates to feeding apparatuses. More particularly, the invention relates to an animal feeder with recessed lighting strips charged either by a battery or by a solar rechargeable battery.

### BACKGROUND

Feeders have been used over the years to attract and feed wild animals for various purposes. In some cases, they have been used to observe them from close quarters. Alternately, they are used for hunting purposes or merely for providing feed. Traditionally, such feeders have been powered by multiple methods so they do not require external power. Conventionally, in such feeders, also referred to as a hopper, solar panels are mounted on the side of a hopper or under a hopper or barrel wherein the connecting wires are exposed. Animals can become entangled on the exposed wires and defecate on the solar panels, which leads to destruction of the solar panels or the animals. This also applies to exposed lights, if any, provided on the feeder. Furthermore, the solar panels are mounted screwed on to the outside of the feeder with the wiring exposed for the varmints or livestock to destroy. When mounted on the outside the birds defecate down the side of the feeder and cover the solar panel with feces, which decreases the function of the solar panel. A feeder with lights, which has connecting wires, lights, and solar panels protected from external damage, is required.

Additionally, in existing feeders, lights have been a stick on aftermarket light that are added based on availability and requirement. Alternately, a separate light is provided to be strapped on to the side of a feeder or a tree to illuminate the feeder. These lights illuminate the area around the feeder thus allowing the animal to be visible in the dark and can be seen very well looking through a riflescope or binoculars. If the connecting wires of these lights, or the lights as well are exposed, they are prone to damage. A feeder, which has lights with their connections and lights inset and protected, is required.

Hence, there is a long felt but unresolved need for a feeder, which has connecting wires, lights and the solar panel protected from external damage. Furthermore, there is a need for a feeder, which has light strips with their connections and lights inset and protected.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The animal feeder, disclosed herein addresses the above-mentioned need for an animal feeder, which has connecting wires, lights, and a solar panel protected from external damage. Furthermore, the invention addresses a need for a feeder, which has recessed light strips with their connections protected. The animal feeder, disclosed herein, for dispensing feed at predefined intervals comprises an animal feeder, at least four recessed lighting strips, a solar panel, connecting wires and a control unit. The animal feeder for dispensing feed comprises a lid, a cage member, and four legs. The lid seals the animal feeder and the cage member is positioned below the animal feeder. The four legs support the cage member and the animal feeder. The recessed lighting strips are attached to predetermined sections of the animal feeder. The solar panel is mounted on a sidewall but is inset at an angle and recessed inside the sidewall. The sidewall is configured to position the solar panel at an inclination for receiving sunlight as well as preventing exposure of the solar panel to free falling objects. The solar panel powers a rechargeable battery in a control unit positioned on an inner surface of the animal feeder for powering the lighting strips. The control unit actuates a supply port for dispensing feed at the predefined intervals.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a front perspective view of an animal feeder.

### DETAILED DESCRIPTION OF THE INVENTION

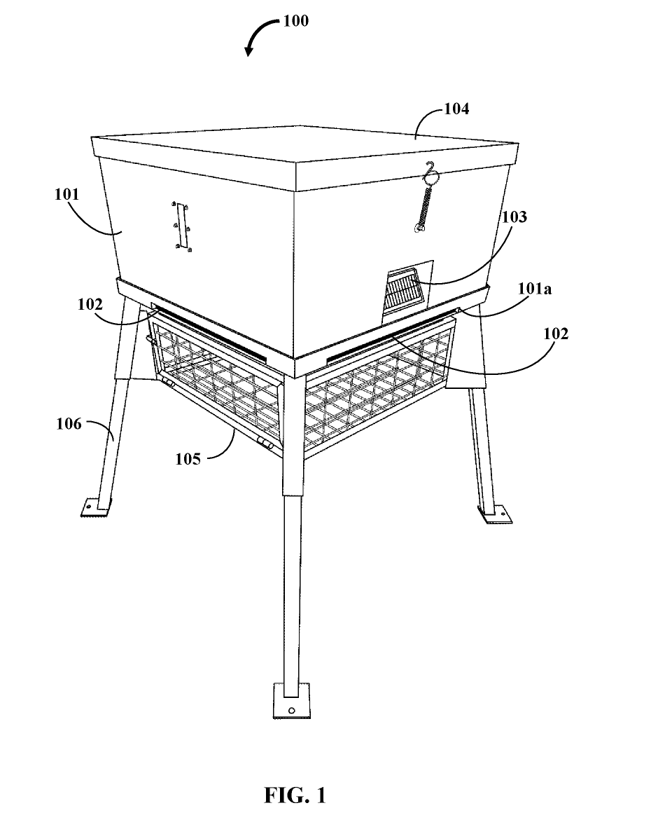

FIG. 1 exemplarily illustrates a front perspective view of an animal feeder 100. The animal feeder 100, disclosed herein, for dispensing feed at predefined intervals comprises an animal feeder 101, at least four recessed lighting strips 102, a recessed solar panel 103, a battery or rechargeable battery and a control unit. The animal feeder 101 for dispensing feed comprises a lid 104, a cage member 105, and four legs 106. The lid 104 seals the animal feeder 101 and the cage member 105 is positioned below the animal feeder 101. The four legs 106 support the animal feeder 101. The recessed lighting strips 102 are detachably attached to predetermined sections 101a of the cage member 105. In an embodiment, the lighting strips 102 comprise, for example, an incandescent light, a light emitting diode (LED), a halogen lamp, etc. In an embodiment, the predetermined sections 101a are positioned along the edges of the cage member 105. However, the lighting strips 102 are placed on similar predetermined sections 101a, for example, the sidewalls, etc., based on the preference of the user.

In an embodiment, the lighting strips 102 are of a generally rectangular configuration. The cage member 105 is designed to protect the control unit and its components. In an embodiment, the recessed solar panel 103 is mounted inset on a sidewall of the animal feeder 101. The recessed solar panel 103 is positioned at an inclination for receiving sunlight and preventing exposure of the recessed solar panel 103 to free falling objects, animals, livestock, etc. The free falling objects comprise objects, for example, dry leaves, bird dropping, animal dropping, etc. The recessed solar panel 103 powers a battery in the control unit positioned under the animal feeder 101 on an inner surface of the animal feeder 101 for powering the at least four lighting strips 102. The recessed solar panel 103 keeps the battery charged. The recessed solar panel 103 itself is angled which protects it as well as all wiring from the elements, animals, and livestock. This also applies to the lighting strips 102. The control unit actuates a supply port for dispensing feed at the predefined intervals.

A space is inset into the sidewall of the animal feeder 101 as exemplarily illustrated in FIG. 1. This design allows the recessed solar panel 103 to be mounted into this inset design. This design allows the recessed solar panel 103 to be mounted at an angle where the light and or sun can be harvested to insure that the battery inside the control unit stays charged to service the function of the control unit and its timer allowing it to dispense feed and run the lighting strips 102 at the predefined intervals. By insetting the solar panel 103, all the wires connecting the solar panel 103 to the control unit are hidden and protected from damage. The wires are run through the animal feeder 101. This design keeps the recessed solar panel 103 and its wiring protected from varmints, livestock, and the weather. With this design, the animal feeder 101 is given a smooth and flush look. In an embodiment, the feeder cage frame has LED strip lights added. These light sources are hidden in a V shaped slot to protect the light sources from the varmints. The wiring is run through the animal feeder 101 to the control unit for protection. The insetting of these two designs protects the recessed lighting strips 102 and the recessed solar panel 103 because they are hidden in a manner that the varmints cannot hang or grab on to them causing destruction to the components, recessed solar panel 103 and the recessed lighting strips 102 of the animal feeder 100.

The cage member 105 is square with an angle top to cradle the animal feeder 101. In an embodiment, the cage member 105 has a two-inch space from the top down. This space allows the feed to be dispursed through the two-inch cage spaces. In an embodiment, a full-length door is provided on one side to access the control unit and components. The control unit actuates a supply port to dispense feed at the predefined intervals. In an embodiment, the predefined intervals are set on the control unit based on user preference. Moreover, the predefined intervals are modifiable on the control unit based on the user preference. This design allows the recessed solar panel 103 to be inset in to the sidewall 101. This protects the recessed solar panel 103 and its wires. The recessed solar panel 103 prevents or eliminates the risk of any animal hanging on it or defecating on the recessed solar panel 103, which would lead to destruction of the recessed solar panel 103, the lighting strips 102, and its wires.

The foregoing examples have been provided merely for the purpose of explanation and are in no way to be construed as limiting of the animal feeder 100, disclosed herein. While the animal feeder 100 has been described with reference to various embodiments, it is understood that the words, which have been used herein, are words of description and illustration, rather than words of limitation. Further, although the animal feeder 100, has been described herein with reference to particular means, materials, and embodiments, the animal feeder 100 is not intended to be limited to the particulars disclosed herein; rather, the animal feeder 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the animal feeder 100 disclosed herein in their aspects.

What is claimed is:

1. An animal feeder for dispensing feed at predefined intervals, the animal feeder comprising:
an animal feeder for dispensing feed comprising a lid, a cage member, and four legs, wherein the lid seals the animal feeder, wherein the cage member is positioned below the animal feeder, and wherein the four legs support the animal feeder;
at least four recessed lighting strips detachably attached with unexposed wiring connections at predetermined sections of the animal feeder;
a recessed solar panel mounted within a sidewall of the animal feeder with unexposed wiring connections, the sidewall configured to position the recessed solar panel at an inclination for receiving sunlight, wherein the sidewall is further configured to prevent exposure of the solar panel to one of free falling objects, animals, and livestock, and wherein the recessed solar panel powers a rechargeable battery in a control unit; and
the control unit positioned on an inner surface of the animal feeder for powering the at least four recessed lighting strips, wherein the control unit actuates a supply port for dispensing feed at the predefined intervals.

2. The animal feeder of claim 1, wherein each of the at least four recessed lighting strips comprise one or more of a light emitting diode (LED).

3. The animal feeder of claim 1, wherein the free falling objects comprise dry leaves, bird dropping, and animal dropping.

4. The animal feeder of claim 1, wherein each of the at least four recessed lighting strips are of a generally rectangular configuration.

5. The animal feeder of claim 1, wherein the wiring connections are all unexposed for protection from both the elements and animal destruction.
